(19) United States
(12) Patent Application Publication
(10) Pub. No.: US 2026/0332859 A1
(43) Pub. Date: Oct. 22, 2026

(54) METHOD, APPARATUS, DEVICE, AND STORAGE MEDIUM FOR DATA PROCESSING

(71) Applicants: Beijing Zitiao Network Technology Co., Ltd., Beijing (CN); Bytedance Technology Ltd., Grand Cayman (KY)

(72) Inventors: Xiaobin ZHUANG, Beijing (CN); Zhuo CHEN, Los Angeles, CA (US); Yuping WANG, Beijing (CN); Yuxuan WANG, Los Angeles, CA (US)

(21) Appl. No.: 19/543,356

(22) Filed: Feb. 18, 2026

(30) Foreign Application Priority Data
Feb. 18, 2025 (CN) 202510179952.2

(51) Int. Cl. H04N 21/81; H04N 21/845; H04N 21/854

(52) U.S. Cl. CPC H04N 21/8106; H04N 21/8456; H04N 21/854

(57) ABSTRACT

A method, an apparatus, a device, and a storage medium for data processing are provided. Based on scene information of a plurality of video segments of a sample video, a set of candidate video segments is determined from the plurality of video segments. A set of candidate audio segments is determined by removing speech content from a plurality of audio segments of a sample audio. Correlation information between the set of candidate video segments and the set of candidate audio segments is determined. At least one sample pair is determined based on the correlation information, and each sample pair includes a video segment and a corresponding audio segment. Based on the at least one sample pair, a training dataset for training an audio generation model is constructed, and the audio generation model is configured to generate audio content corresponding to an input video.

### CROSS-REFERENCE

This application claims priority to Chinese Patent Application No. 202510179952.2, filed on Feb. 18, 2025, and entitled “METHOD, APPARATUS, DEVICE, AND STORAGE MEDIUM FOR DATA PROCESSING”, the disclosure of which is incorporated herein by reference in its entirety.

### FIELD

Example embodiments of the present disclosure generally relate to the field of computers, and in particular, to a method, an apparatus, a device, and a computer-readable storage medium for data processing.

### BACKGROUND

With the rapid development of computer technologies, audio generation techniques based on machine learning models (e.g., audio generation models) may be used to synthesize higher-quality audio more efficiently for use in scenarios such as film and television production, game development, advertisement creation, virtual reality, and augmented reality. By improving the quality of training samples for training these audio generation models, the training performance of the audio generation models can be improved, thereby improving the quality of audio content generated by the audio generation models.

### SUMMARY

In a first aspect of the present disclosure, a method of data processing is provided. The method includes: determining, based on scene information of a plurality of video segments of a sample video, a set of candidate video segments from the plurality of video segments; determining a set of candidate audio segments by removing speech content from a plurality of audio segments of a sample audio; determining correlation information between the set of candidate video segments and the set of candidate audio segments; determining at least one sample pair based on the correlation information, each sample pair including a video segment and a corresponding audio segment; and constructing, based on the at least one sample pair, a training dataset for training an audio generation model, the audio generation model being configured to generate audio content corresponding to an input video.

In a second aspect of the present disclosure, an apparatus for data processing is provided. The apparatus includes: a first determination module configured to determine, based on scene information of a plurality of video segments of a sample video, a set of candidate video segments from the plurality of video segments; a second determination module configured to determine a set of candidate audio segments by removing speech content from a plurality of audio segments of a sample audio; a third determination module configured to determine correlation information between the set of candidate video segments and the set of candidate audio segments; a fourth determination module configured to determine at least one sample pair based on the correlation information, each sample pair including a video segment and a corresponding audio segment; and a construction module configured to construct, based on the at least one sample pair, a training dataset for training an audio generation model, the audio generation model being configured to generate audio content corresponding to an input video.

In a third aspect of the present disclosure, an electronic device is provided. The electronic device includes at least one processor; and at least one memory, the at least one memory being coupled to the at least one processor and storing instructions executable by the at least one processor. The instructions, when executed by the at least one processor, causes the electronic device to perform the method of the first aspect.

In a fourth aspect of the present disclosure, a non-transitory computer-readable storage medium is provided. The non-transitory computer-readable storage medium has a computer program stored thereon, and the computer program, when executed by a processor, implements the method of the first aspect.

It would be appreciated that the content described in this summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference numbers refer to the same or similar elements, where:

FIG. 1 shows a schematic diagram of an example environment in which the embodiments according to the present disclosure may be implemented;

FIG. 2 shows a schematic diagram of an example sample construction process according to some embodiments of the present disclosure;

FIG. 3 shows a flowchart of an example process of data processing according to some embodiments of the present disclosure;

FIG. 4 shows a schematic structural block diagram of an example apparatus for data processing according to some embodiments of the present disclosure; and

FIG. 5 shows a block diagram of an electronic device capable of implementing multiple embodiments of the present disclosure.

### DETAILED DESCRIPTION OF EMBODIMENTS

The embodiments of the present disclosure will be described in more detail below with reference to the drawings. Although some embodiments of the present disclosure are shown in the drawings, it would be appreciated that the present disclosure may be implemented in various forms, and should not be interpreted as limited to the embodiments set forth herein. Rather, these embodiments are provided for a more thorough and complete understanding of the present disclosure. It would be appreciated that the drawings and embodiments of the present disclosure are only for illustrative purposes, and are not intended to limit the protection scope of the present disclosure.

It would be noted that the titles of any sections/subsections provided herein are not restrictive. Various embodiments are described throughout this document, and any type of embodiment may be included under any section/subsection. In addition, the embodiments described in any section/subsection may be combined with any other embodiments described in the same section/subsection and/or different sections/subsections in any manner.

In the description of the embodiments of the present disclosure, the term “include/comprise” and its similar terms should be understood as open-ended inclusion, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or same objects. Other explicit and implicit definitions may also be included below.

The embodiments of the present disclosure may involve user data, data acquisition and/or data usage, and the like. These aspects follow corresponding laws, regulations and related provisions. In the embodiments of the present disclosure, all data collection, acquisition, processing, manufacturing, forwarding and usage are performed on the premise that the user knows and confirms. Accordingly, when implementing the embodiments of the present disclosure, the user should be informed of the type, usage range, usage scenario, etc. of the data or information that may be involved and the authorization of the user should be obtained through an appropriate method according to relevant laws and regulations. The specific notification and/or authorization method may vary according to the actual situation and application scenario, and the scope of the present disclosure is not limited in this regard.

The solutions in this specification and the embodiments, if involving personal information processing, are all processed on the premise of having a legal basis (for example, obtaining the consent of the personal information subject, or being necessary for fulfilling a contract, etc.), and are only processed within the specified or agreed scope. If the user refuses to process personal information other than the necessary information required for the basic function, it will not affect the user’s use of the basic function.

As briefly mentioned above, audio generation techniques (e.g., audio generation models) implemented based on machine learning models may be applied to the synthesis of audio such as speech, music, and sound effects for use in scenarios such as film and television production, game development, advertisement creation, virtual reality, and augmented reality. By improving the quality of training sample sets for training these audio generation models, the training effects of the audio generation models can be improved, and the quality of audio content generated by the audio generation models can be improved.

In order to ensure the quality of audio content generated by such audio generation models, traditional techniques usually train appropriate audio generation models separately for specified scenarios, such as an audio generation model for video soundtrack, an audio generation model for video dubbing, and an audio generation model for generating sound effects for input videos, etc. Therefore, traditional techniques construct training sample sets by using sample data collected in specified scenarios. However, the data volume of the training sample set of this solution is too small and the sample quality cannot be guaranteed, which in turn affects the training effect of the audio generation model and the quality of the trained audio generation model.

The embodiments of the present disclosure propose a solution for data processing. According to this solution, based on scene information of a plurality of video segments of a sample video, a set of candidate video segments may be determined from the plurality of video segments. Further, a set of candidate audio segments may be determined by removing speech content from a plurality of audio segments of a sample audio. Further, correlation information between the set of candidate video segments and the set of candidate audio segments may be determined. Further, at least one sample pair may be determined based on the correlation information, each sample pair including a video segment and a corresponding audio segment. Additionally, a training dataset for training an audio generation model may be constructed based on the at least one sample pair, the audio generation model being configured to generate audio content corresponding to an input video.

Based on this approach, the embodiments of the present disclosure may determine such a set of candidate video segments based on the scene information of the plurality of video segments of the sample video, thereby reducing the influence of some scenes that interfere with the training of the audio generation model on the subsequent training process of the audio generation model. Further, by removing the speech content from the plurality of audio segments of the sample audio, the embodiments of the present disclosure may prevent the speech content from interfering with the training process of the audio generation model. Further, by determining the correlation information between the set of candidate video segments and the set of candidate audio segments, the embodiments of the present disclosure may increase a matching degree between the video segment and the audio segment included in the sample pair, thereby improving the quality of the sample pair. Therefore, based on the more relevant sample pair determined from the set of candidate audio segments with higher quality and the set of candidate audio segments with higher quality, the embodiments of the present disclosure may use the sample video and the sample audio with a larger data volume to construct a higher-quality training dataset for a specified scene, thereby improving the training effect of the audio generation model and improving the quality of the audio content corresponding to the input video generated subsequently based on the audio generation model.

Therefore, the embodiments of the present disclosure can improve the quality of a set of candidate video segments based on the scene information of the video segments, improve the quality of a set of candidate audio segments by removing speech content from the audio segments, and improve the quality of the sample pair by ensuring the correlation between the video segment and the audio segment in the sample pair, thereby improving the quality of the training dataset constructed based on the sample pair. Further, the embodiments of the present disclosure can also improve the training effect and model quality of the audio generation model trained subsequently based on the training dataset.

Various example implementations of the solution will be described in detail below with further reference to the drawings.

### Example Environment

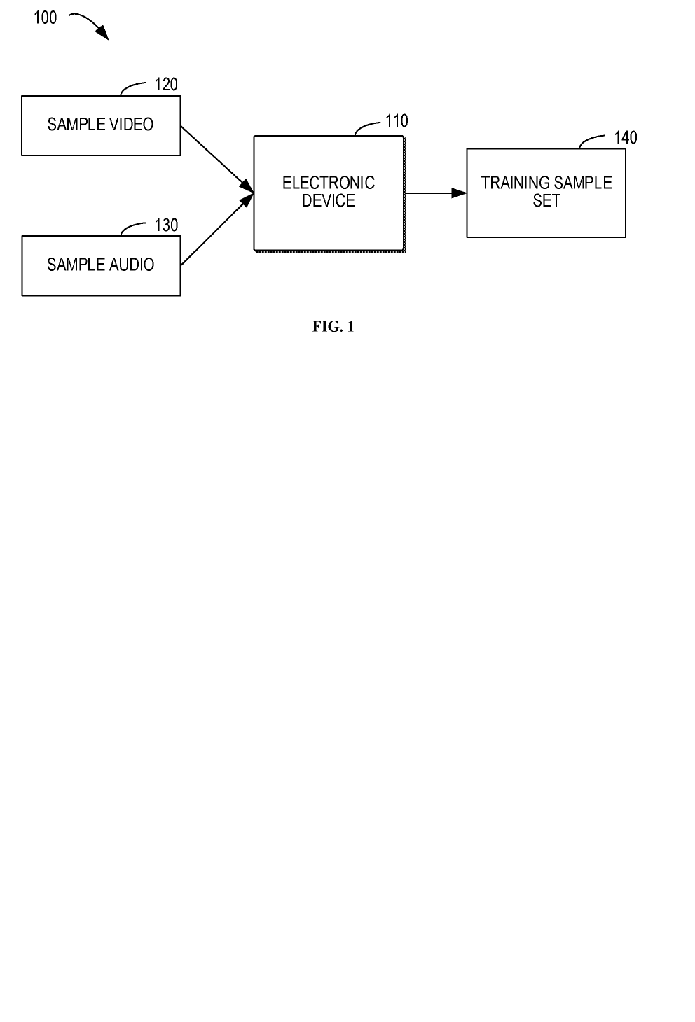

FIG. 1 shows a schematic diagram of an example environment 100 in which the embodiments of the present disclosure may be implemented. In this example environment 100, an electronic device 110 may perform data processing on a sample video 120 and a sample audio 130 to construct a training sample set 140 for training an audio generation model. The electronic device 110 may include any computing system with computing power, such as various computing devices/systems, terminal devices, and/or server devices, etc.

The terminal device may be any type of mobile terminal, fixed terminal or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination of the foregoing, including the accessories and peripherals of these devices, or any combination thereof. In some embodiments, the terminal device may also support any type of user-specific interface (such as “wearable” circuitry, etc.).

The server device may be an independent physical server, a server cluster or distributed system composed of multiple physical servers, or may be a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server device may include, for example, a computing system/server, such as a mainframe, an edge computing node, a computing device in a cloud environment, and the like.

A communication connection may be established between the server device and the terminal device. The communication connection may be established by wired or wireless means. The communication connection may include but not be limited to a Bluetooth connection, a mobile network connection, a Universal Serial Bus (USB) connection, a Wireless Fidelity (WiFi) connection, etc., and the embodiments of the present disclosure are not limited in this regard. In the embodiments of the present disclosure, the server device and the terminal device may implement signaling interaction through the communication connection between them.

It would be appreciated that structures and functions of various elements in the environment 100 are described for illustrative purposes only, without suggesting any limitation to the scope of the present disclosure.

Some example embodiments of the present disclosure will be described below with continued reference to the drawings.

### Example Sample Construction Process

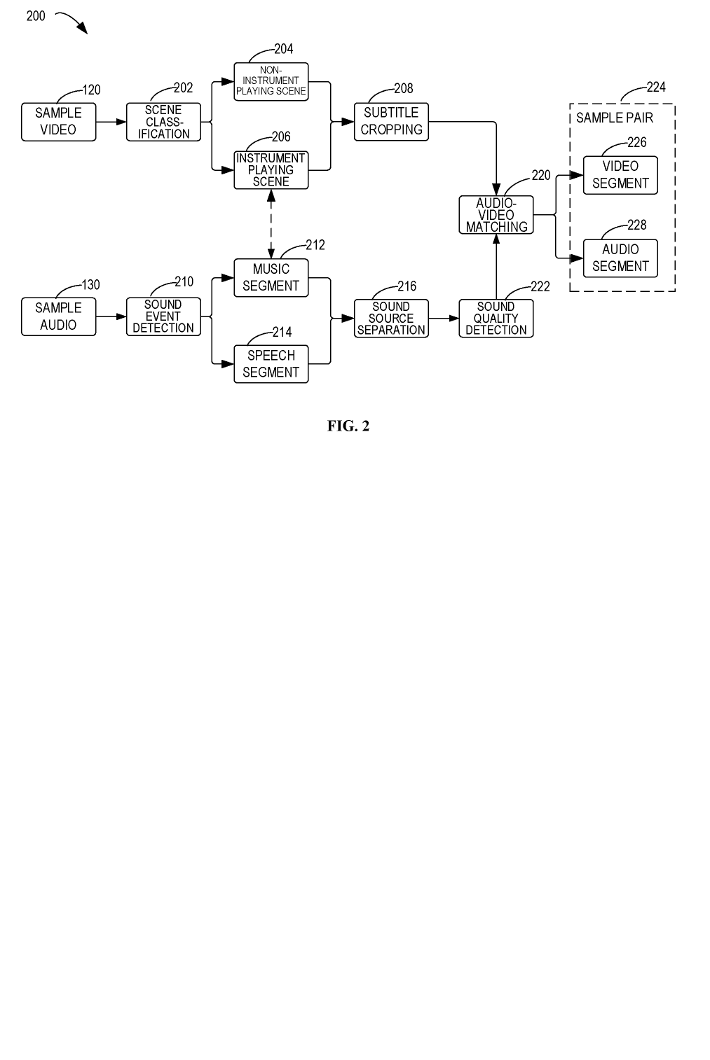

Some example sample construction processes according to the embodiments of the present disclosure will be described below with reference to FIG. 2. FIG. 2 shows a schematic diagram of an example sample construction process according to some embodiments of the present disclosure. The process 200 may be provided, for example, by the electronic device 110 shown in FIG. 1.

In some embodiments, the electronic device 110 may directly construct a training sample set of an audio generation model by using sample data, but the quality of such a training sample set is low, resulting in poor training performance of the audio generation model. Based on this, in some embodiments, the electronic device 110 may perform data processing on the sample data to determine at least one sample pair including a video segment and an audio segment, and then construct a training sample set for training the audio generation model based on the at least one sample pair. As an example, the sample data may include at least one sample video and at least one sample audio, and therefore the embodiments of the present disclosure may perform data processing on at least the at least one sample video and the at least one sample audio. As an example, the at least one sample video and the at least one sample audio may be extracted and obtained based on the same video content, or may correspond to different media content sources. Therefore, the embodiments of the present disclosure may ensure the data volume of the collected sample data.

The following embodiments of the present disclosure are illustratively described by taking the electronic device 110 performing data processing on the sample video 120 and the sample audio 130 to construct a corresponding training sample set as an example. The specific implementation of the electronic device 110 performing data processing on a plurality of sample videos and a plurality of sample audios is implemented by reusing such a data processing process, which will not be repeated in the embodiments of the present disclosure.

As an example, the sample video 120 may include image content in at least one scene, examples of which include, but are not limited to, an indoor scene, an outdoor scene, a static image, a dynamic image, etc. The sample audio 130 may include audio of at least one sound type, examples of which include, but are not limited to, speech, music, etc. In order to ensure the quality of the audio generation model obtained in subsequent training in a specified scene, the electronic device 110 may perform data cleaning on the sample video 120 and the sample audio 130. In the following, the specified scene is a sound effect generation scene as an example, that is, the audio generation model is used to generate sound effect content corresponding to an input video. It would be appreciated that the specified scene is only used to clearly describe the embodiments of the present disclosure, and the present disclosure is not intended to limit the specific application scene of the audio generation model.

In the description of the embodiments of the present disclosure, the term “sound effect” and its similar terms should be understood as the effect created by sound. Sound effects (also known as sound effect content) are widely used in movies, electronic games, music and other media, and the art effect of media content may be enhanced through artificial sound effects or enhanced sound effects. Generally, sound effects are applied in the processing of media content, rather than through the dialogue or music in the media content itself. For example, sound effects may include thunder, hoofbeats, birdcalls, applause, car honking, etc.

In some embodiments, the electronic device 110 determines a set of candidate video segments from a plurality of video segments based on scene information of a plurality of video segments of the sample video 120, and thus the electronic device 110 may reduce the interference of video content in other scenes unrelated to the specified scene on the subsequent training process of the audio generation model. As an example, the scene information includes, but is not limited to, image content corresponding to the video content (e.g., static images, dynamic images, etc.), environmental information (e.g., an indoor environment, an outdoor environment), image elements (e.g., an instrument playing scene, a non-instrument playing scene) and the like. Therefore, the electronic device 110 may determine a set of candidate video segments with less interference from the plurality of video segments of the sample video 120 to improve the quality of the set of candidate video segments.

In some embodiments, the sample video 120 may be associated with a plurality of shots (also known as storyboards). In order to ensure the accuracy of the scene information of the plurality of video segments of the sample video, the electronic device 110 may segment the sample video into the plurality of video segments corresponding to different storyboards. As an example, such a shot detection tool may include any appropriate shot detection algorithm, etc., and the present disclosure is not intended to limit the specific implementation of shot detection.

Further, the electronic device 110 may perform scene recognition for the video segment under each storyboard, thereby improving the accuracy of scene recognition. As an example, such scene recognition may be implemented by any suitable model, for example, a pre-trained scene classification model 202. The scene classification model 202 may perform scene classification on the input video segment to obtain the corresponding scene.

In some embodiments, the electronic device 110 may determine, based on the scene information of the plurality of video segments of the sample video 120, whether the plurality of video segments include a video segment corresponding to a preset scene. As an example, the preset scene may be a scene that interferes with the training effects of the audio generation model. For example, the specified scene may indicate a video scene with a high probability of occurrence of sound effects, such as a dynamic image scene, an outdoor scene, etc. The preset scene may indicate a video scene with a low probability of occurrence of sound effects. For example, the preset scene may indicate that the video segment corresponds to a static image. Additionally or alternatively, the preset scene may indicate that the video segment corresponds to an indoor environment.

Further, if the plurality of video segments include a video segment corresponding to the preset scene, the electronic device 110 may remove at least one video segment corresponding to the preset scene from the plurality of video segments to obtain a set of video segments (marked as a set “A” of video segments for ease of distinction). As an example, the electronic device 110 may use the set “A” of video segments as the set of candidate video segments.

In some embodiments, the instrument playing scene may be associated with instrument playing sound effects. In order to improve the training effects of the audio generation model, the electronic device 110 may provide the audio generation model with samples corresponding to the instrument playing scene for learning. As an example, if the plurality of video segments include a video segment corresponding to an instrument playing scene 206, the electronic device 110 may add the video segment corresponding to the instrument playing scene 206 to the set of candidate video segments. As a video segment of the plurality of video segments corresponds to a non-instrument playing scene 204 and corresponds to the preset scene, the electronic device 110 may remove the video segment corresponding to the non-instrument playing scene 204 and corresponding to the preset scene from the plurality of video segments. Therefore, the electronic device 110 may retain the video segment related to the instrument playing scene, thereby improving the diversity of the audio generated by the audio generation model.

In some embodiments, if the set of candidate video segments contains subtitle content, the subtitle content may affect the subsequent training process of the audio generation model. Therefore, the electronic device 110 may also crop an image part corresponding to the subtitle content from the set of candidate video segments to obtain a cropped set of candidate video segments (for example, marked as a set “B” of video segments). As an example, the electronic device 110 may use a subtitle cropping tool 208 to implement such a cropping process, and the subtitle cropping tool may include any model that may crop specified content in a video or a media editing tool that includes any appropriate subtitle detection algorithm, etc.

Based on the video processing process, the electronic device 110 may obtain a set of candidate video segments with high quality. Further, the electronic device 110 may process the sample audio 130 to improve the quality of a determined set of candidate audio segments. Specifically, the electronic device 110 determines a set of candidate audio segments by removing speech content from a plurality of audio segments of the sample audio 130. Therefore, the embodiments of the present disclosure can prevent the speech content from affecting the training process of the audio generation model.

In order to ensure the accuracy of subsequent matching with a set of candidate video segments, the electronic device 110 may segment the sample audio 130 to obtain an audio segment set corresponding to a preset length. As an example, the preset length may be consistent with a length of the plurality of video segments of the sample video 120 described above. Further, the electronic device 110 may determine, using a sound event detection model 210, a plurality of audio segments containing sound events from the audio segment set. As an example, the sound event may correspond to an event of audio content that needs to be output by the audio generation model, for example, a sound effect event. Therefore, the embodiments of the present disclosure may prevent audio segments unrelated to the sound events from interfering with the subsequent training process of the audio generation model, thereby improving the training effects of the subsequent audio generation model.

In some embodiments, the electronic device 110 may also retain the audio segment related to instrument playing and remove the music segment unrelated to instrument playing from the audio segment to improve the diversity of audio content generated by the subsequent audio generation model. Specifically, taking the electronic device 110 performing audio processing on a first audio segment as an example, if the first audio segment contains music content (for example, the first audio segment is a music segment 212), the electronic device 110 may determine a target video segment corresponding to the first audio segment.

Further, if the target video segment is related to the instrument playing scene, the electronic device 110 may retain the music content in the first audio segment, and determine a candidate audio segment corresponding to the first audio segment by removing the speech content from the first audio segment. If the target video segment is not related to the instrument playing scene, for example, the first audio segment is a speech segment 214, the electronic device 110 may determine a candidate audio segment corresponding to the first audio segment by removing the music content and the speech content from the first audio segment. In this way, the embodiments of the present disclosure can improve the diversity of audio content generated by the subsequent audio generation model, while preventing the speech content, music content in non-instrument playing scenes, etc. from interfering with the subsequent training process for the audio generation model.

In some embodiments, the higher the energy of the speech content removed by the electronic device 110, the more severely the sound quality of the obtained audio segment is damaged. Therefore, if the energy of the speech content removed from an audio segment exceeds a first threshold, the electronic device 110 may remove such an audio segment to ensure the sound quality of a set of candidate audio segments. As an example, taking a second audio segment as an example, the electronic device 110 may determine the energy corresponding to the speech content removed from the second audio segment. As an example, the second audio segment and the first audio segment may be the same audio segment or different audio segments, for example, the second audio segment may be obtained by processing the first audio segment, or the first audio segment may be obtained by processing the second audio segment.

In some embodiments, the electronic device 110 may use a sound source separation tool 216 (for example, any tool or model that may implement speech and audio separation, etc.) to remove the speech content from the audio segment, or may crop out a part containing the speech content in the audio segment, and the present disclosure is not intended to limit the specific implementation of removing the speech content. Further, the electronic device 110 may use a sound quality detection tool 222 (for example, any tool or model that may detect the energy of speech content, etc.) to detect the energy corresponding to the speech content removed from the second audio segment. If the energy corresponding to the speech content removed from the second audio segment is less than the first threshold, the electronic device 110 may add the second audio segment from which the speech content has been removed to the set of candidate audio segments.

Based on the audio processing process, the embodiments of the present disclosure may obtain a set of candidate audio segments with high quality. Further, the electronic device 110 may determine correlation information between the set of candidate video segments and the set of candidate audio segments, and pair the set of candidate video segments (a set “A” of candidate video segments, a set “B” of candidate video segments, etc.) with the set of candidate audio segments based on the correlation information, thereby increasing the matching degree between a video segment 226 and a corresponding audio segment 228 in a determined sample pair 224, and further improving the quality of the sample pair.

Specifically, the electronic device 110 may determine, based on the correlation information between the set of candidate video segments and the set of candidate audio segments, a video segment and an audio segment whose matching degree is greater than a second threshold, to determine the sample pair 224 based on the video segment and the audio segment whose matching degree is greater than the second threshold. Further, the electronic device 110 may construct a training sample set for training the audio generation model based on the sample pair 224, thereby improving the quality of the training sample set.

In some embodiments, the electronic device 110 may use an audio-video matching unit 220 to determine correlation information between a candidate video segment and a candidate audio segment by representing a similarity. Specifically, the electronic device 110 may encode a plurality of image frames in the candidate video segment to determine a plurality of image feature representations. Further, the electronic device 110 may determine a video feature representation corresponding to the candidate video segment based on the plurality of image feature representations. Further, the electronic device 110 may determine a similarity between the video feature representation and an audio feature representation of the candidate audio segment. Further, the electronic device 110 may determine the correlation information between the candidate video segment and the candidate audio segment based on the similarity. As an example, the similarity between the video feature representation and the audio feature representation of the candidate audio segment may be determined by a variety of feature similarity calculation methods, such as vector distance, cosine similarity, etc., and the present disclosure is not intended to limit the feature similarity calculation methods.

In some embodiments, the electronic device 110 may also perform joint classification for the set of candidate video segments and the set of candidate audio segments by the audio-video matching unit 220, and then classify joint features by using a joint feature classification model, to determine the correlation information between the set of candidate video segments and the set of candidate audio segments. As an example, the joint classification may include a plurality of implementations, such as random grouping, grouping based on preset rules, etc., and the joint feature classification model may also be implemented by any appropriate model, and the present disclosure is not intended to limit the joint classification manner and the classification manner of correlation information. Therefore, the embodiments of the present disclosure can improve the quality of the constructed training sample set in terms of improving audio quality, improving video quality, and improving audio-video matching degree.

In this way, the embodiments of the present disclosure can determine such a set of candidate video segments based on the scene information of the plurality of video segments of the sample video, thereby reducing the influence of some scenes that interfere with the training of the audio generation model on the subsequent training process of the audio generation model. Further, by removing the speech content from the plurality of audio segments of the sample audio, the embodiments of the present disclosure can prevent the speech content from interfering with the training process of the audio generation model. Further, by determining the correlation information between the set of candidate video segments and the set of candidate audio segments, the embodiments of the present disclosure may increase the matching degree between the video segment and the audio segment included in the sample pair, thereby improving the quality of the sample pair. Therefore, based on the more relevant sample pair determined from the set of candidate audio segments with higher quality and the set of candidate audio segments with higher quality, the embodiments of the present disclosure may construct a higher-quality training dataset for a specified scene, thereby improving the training effect of the audio generation model and the quality of the audio content corresponding to the input video generated subsequently based on the audio generation model.

Therefore, the embodiments of the present disclosure can improve the quality of a set of candidate video segments based on the scene information of the video segments, improve the quality of a set of candidate audio segments by removing speech content from the audio segment, and improve the quality of sample pair by ensuring the correlation between the video segment and the audio segment in the sample pair, thereby improving the quality of the training dataset constructed based on the sample pair. Further, the embodiments of the present disclosure can also improve the training effect and model quality of the subsequently trained audio generation model based on the training dataset.

### Example Process

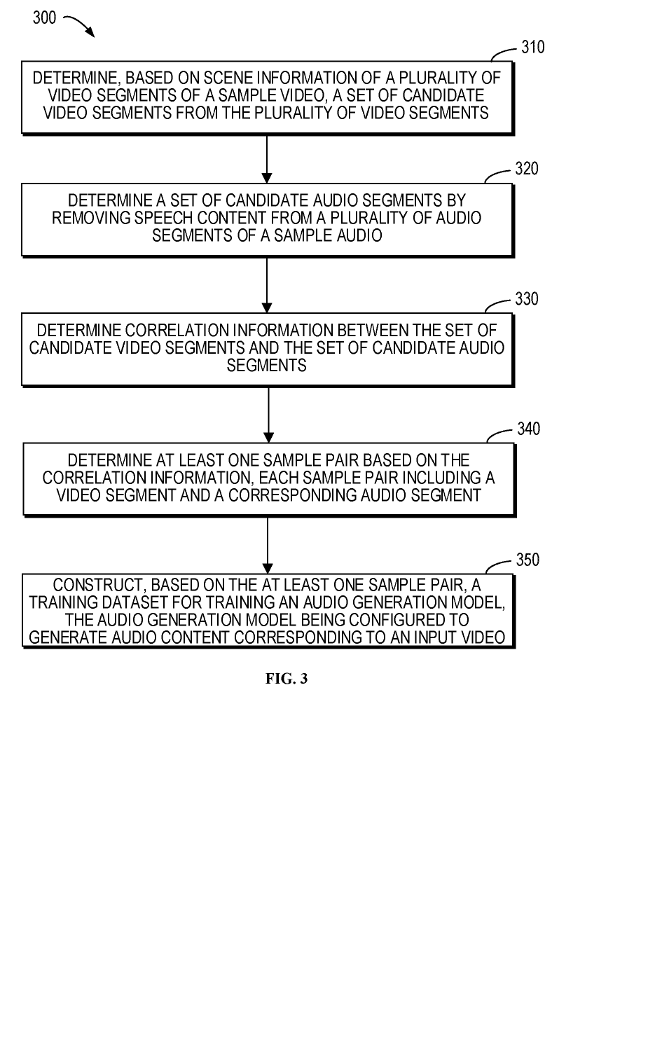

FIG. 3 shows a flowchart of an example process 300 of data processing according to some embodiments of the present disclosure. The process 300 may be implemented at the electronic device 110. The process 300 is described below with reference to FIG. 1.

As shown in FIG. 3, at block 310, the electronic device 110 determines, based on scene information of a plurality of video segments of a sample video, a set of candidate video segments from the plurality of video segments.

At block 320, the electronic device 110 determines a set of candidate audio segments by removing speech content from a plurality of audio segments of a sample audio.

At block 330, the electronic device 110 determines correlation information between the set of candidate video segments and the set of candidate audio segments.

At block 340, the electronic device 110 determines at least one sample pair based on the correlation information, each sample pair including a video segment and a corresponding audio segment.

At block 350, the electronic device 110 constructs, based on the at least one sample pair, a training dataset for training an audio generation model, the audio generation model being configured to generate audio content corresponding to an input video.

In some embodiments, the process 300 further includes: segmenting the sample video into the plurality of video segments corresponding to different storyboards.

In some embodiments, determining, based on the scene information of the plurality of video segments of the sample video, the set of candidate video segments from the plurality of video segments includes: determining, based on the scene information of the plurality of video segments of the sample video, whether the plurality of video segments include a video segment corresponding to a preset scene; and in response to the plurality of video segments including at least one video segment corresponding to the preset scene, removing the at least one video segment from the plurality of video segments to determine the set of candidate video segments.

In some embodiments, the preset scene indicates at least one of the following: the video segment corresponds to a static image; or the video segment corresponds to an indoor environment.

In some embodiments, determining the correlation information between the set of candidate video segments and the set of candidate audio segments includes: cropping, from the set of candidate video segments, an image part corresponding to subtitle content; and determining the correlation information between the set of cropped candidate video segments and the set of candidate audio segments.

In some embodiments, the process 300 further includes: segmenting the sample audio into an audio segment set corresponding to a preset length; and determining, using a sound event detection model, a plurality of audio segments containing sound events from the audio segment set.

In some embodiments, determining the set of candidate audio segments by removing the speech content from the plurality of audio segments of the sample audio includes: determining a target video segment corresponding to a first audio segment; and in response to determining that image content of the target video segment is not related to instrument playing, removing music content and speech content from the first audio segment to determine a corresponding candidate audio segment.

In some embodiments, determining the set of candidate audio segments by removing the speech content from the plurality of audio segments of the sample audio includes: determining energy corresponding to speech content removed from a second audio segment; and in response to the energy being less than a first threshold, adding the second audio segment from which the speech content has been removed to the set of candidate audio segments.

In some embodiments, a matching degree between the video segment and the corresponding audio segment in the at least one sample pair is greater than a second threshold.

In some embodiments, determining the correlation information between the set of candidate video segments and the set of candidate audio segments includes: encoding a plurality of image frames in a candidate video segment to determine a plurality of image feature representations; determining a video feature representation corresponding to the candidate video segment based on the plurality of image feature representations; determining a similarity between the video feature representation and an audio feature representation of a candidate audio segment; and determining the correlation information between the candidate video segment and the candidate audio segment based on the similarity.

### Example Apparatus and Device

The embodiments of the present disclosure also provide corresponding apparatuses for implementing the above methods or processes. FIG. 4 shows a schematic structural block diagram of an example apparatus 400 for data processing according to some embodiments of the present disclosure. The apparatus 400 may be implemented as or included in the electronic device 110. Each module/component in the apparatus 400 may be implemented by hardware, software, firmware, or any combination thereof.

As shown in FIG. 4, the apparatus 400 includes a first determination module 410 configured to determine, based on scene information of a plurality of video segments of a sample video, a set of candidate video segments from the plurality of video segments; a second determination module 420 configured to determine a set of candidate audio segments by removing speech content from a plurality of audio segments of a sample audio; a third determination module 430 configured to determine correlation information between the set of candidate video segments and the set of candidate audio segments; a fourth determination module 440 configured to determine at least one sample pair based on the correlation information, each sample pair including a video segment and a corresponding audio segment; and a construction module 450 configured to construct, based on the at least one sample pair, a training dataset for training an audio generation model, the audio generation model being configured to generate audio content corresponding to an input video.

In some embodiments, the process 300 further includes: segmenting the sample video into the plurality of video segments corresponding to different storyboards.

In some embodiments, the first determination module 410 is further configured to: determine, based on the scene information of the plurality of video segments of the sample video, whether the plurality of video segments include a video segment corresponding to a preset scene; and in response to the plurality of video segments including at least one video segment corresponding to the preset scene, remove the at least one video segment from the plurality of video segments to determine the set of candidate video segments.

In some embodiments, the preset scene indicates at least one of the following: the video segment corresponds to a static image; or the video segment corresponds to an indoor environment.

In some embodiments, the third determination module 430 is further configured to: crop, from the set of candidate video segments, an image part corresponding to subtitle content; and determine the correlation information between the set of cropped candidate video segments and the set of candidate audio segments.

In some embodiments, the apparatus 400 further includes a fifth determination module configured to: segment the sample audio into an audio segment set corresponding to a preset length; and determine, using a sound event detection model, the plurality of audio segments containing sound events from the audio segment set.

In some embodiments, the second determination module 420 is further configured to: determine a target video segment corresponding to a first audio segment; and in response to determining that image content of the target video segment is not related to instrument playing, remove music content and speech content from the first audio segment to determine a corresponding candidate audio segment.

In some embodiments, the second determination module 420 is further configured to: determine energy corresponding to the speech content removed from a second audio segment; and in response to the energy being less than a first threshold, add the second audio segment from which the speech content has been removed to the set of candidate audio segments.

In some embodiments, a matching degree between the video segment and the corresponding audio segment in the at least one sample pair is greater than a second threshold.

In some embodiments, the third determination module 430 is further configured to: encode a plurality of image frames in a candidate video segment to determine a plurality of image feature representations; determine a video feature representation corresponding to the candidate video segment based on the plurality of image feature representations; determine a similarity between the video feature representation and an audio feature representation of a candidate audio segment; and determine the correlation information between the candidate video segment and the candidate audio segment based on the similarity.

The modules included in the apparatus 400 may be implemented in various ways, including software, hardware, firmware, or any combination thereof. In some embodiments, one or more units may be implemented using software and/or firmware, for example machine executable instructions stored on a storage medium. In addition to machine executable instructions or as an alternative, some or all modules in the apparatus 400 may be implemented at least partially by one or more hardware logic components. As an example, rather than a limitation, example types of hardware logic components that may be used include a field programmable gate array (FPGA), an application specific integrated circuit (ASIC), an application specific standard (ASSP), a system on chip (SOC), a complex programmable logic device (CPLD), and the like.

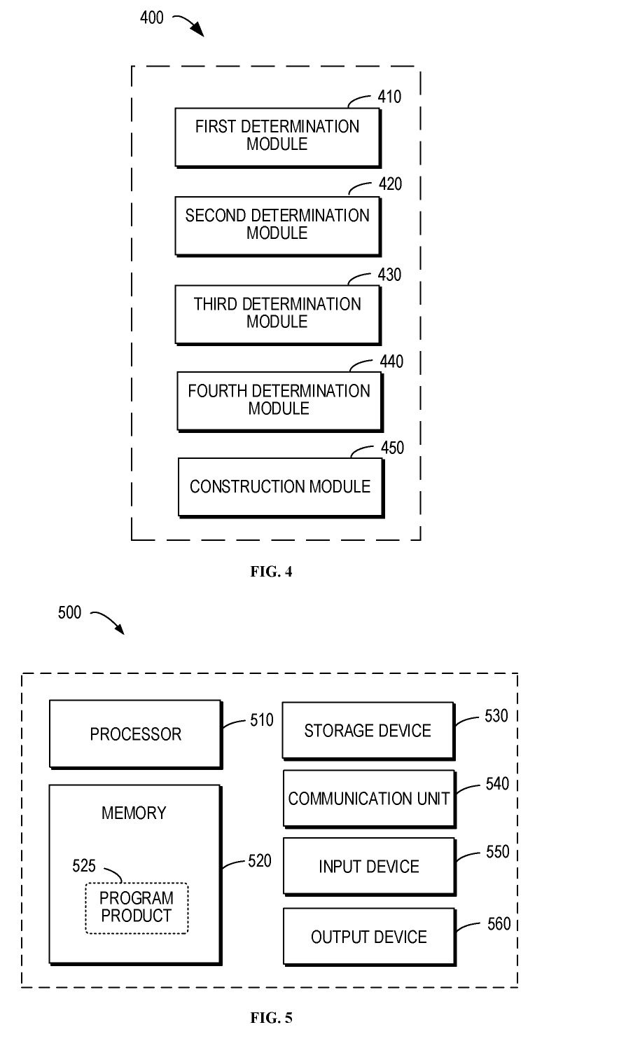

FIG. 5 shows a block diagram of an electronic device 500 in which one or more embodiments of the present disclosure may be implemented. It would be appreciated that the electronic device 500 shown in FIG. 5 is merely illustrative and should not constitute any limitation on the functionality and scope of the embodiments described herein. The electronic device 500 shown in FIG. 5 may be used to implement the electronic device 110 in FIG. 1 or the apparatus 400 in FIG. 4.

As shown in FIG. 5, the electronic device 500 is in the form of a general electronic device. The components of electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and may execute various processes based on the programs stored in the memory 520. In a multiprocessor system, a plurality of processing units execute computer executable instructions in parallel to improve the parallel processing capability of the electronic device 500.

The electronic device 500 typically includes a plurality of computer storage media. Such medium may be any available medium accessible by the electronic device 500, including but not limited to volatile and non-volatile medium, removable and non-removable medium. The memory 520 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 530 may be any removable or non-removable medium, and may include a machine-readable medium such as a flash drive, a disk, or any other medium, which may be used to store information and/or data and may be accessed within the electronic device 500.

The electronic device 500 may further include additional removable/non-removable, volatile/non-volatile memory medium. Although not shown in FIG. 5, a disk drive for reading from or writing into a removable, non-volatile disk (such as a “floppy disk”), and an optical disk drive for reading from or writing into a removable, non-volatile optical disk may be provided. In these cases, each drive may be connected to the bus (not shown) by one or more data medium interfaces. The memory 520 may include a computer program product 525, which has one or more program modules configured to perform various methods or acts of the various embodiments of the present disclosure.

The communication unit 540 implements communication with other electronic devices through the communication medium. In addition, the functions of the components of the electronic device 500 may be implemented by a single computing cluster or multiple computing machines, which may communicate through communication connections. Therefore, the electronic device 500 may use a logical connection with one or more other servers, a network personal computer (PC) or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may also communicate with one or more external devices (not shown) through the communication unit 540 as needed, the external devices such as a storage device, a display device, etc., communicate with one or more devices that enable the user to interact with the electronic device 500, or communicate with any devices (e.g., a network card, a modem, etc.) that enable the electronic device 500 to communicate with one or more other electronic devices. Such communication may be performed via input/output (I/O) interfaces (not shown).

According to an example implementation of the present disclosure, there is provided a computer-readable storage medium having computer executable instructions stored thereon, where the computer executable instructions are executed by a processor to implement the method described above. According to an example implementation of the present disclosure, there is further provided a computer program product tangibly stored on a non-transitory computer-readable medium and including computer executable instructions, which are executed by a processor to implement the method described above.

Various aspects of the present disclosure are described herein with reference to flowcharts and/or block diagrams of methods, apparatuses, devices and computer program products implemented according to the present disclosure. It would be appreciated that each block of the flowchart(s) and/or block diagram(s), and combinations of blocks in the flowchart(s) and/or block diagram(s), may be implemented by computer-readable program instructions.

These computer-readable program instructions may be provided to a processing unit of a general-purpose computer, a special-purpose computer, or other programmable data processing apparatus to produce a machine, such that the instructions, when executed by the processing unit of the computer or other programmable data processing apparatus, produce an apparatus for implementing the functions/acts specified in one or more blocks of the flowchart(s) and/or block diagram(s). These computer-readable program instructions may also be stored in a computer-readable storage medium, and these instructions cause the computer, the programmable data processing apparatus, and/or other devices to work in a specific manner, and thus, the computer-readable medium storing the instructions includes a manufactured product, which includes instructions for implementing various aspects of the functions/acts specified in one or more blocks of the flowchart(s) and/or block diagram(s).

The computer-readable program instructions may be loaded onto a computer, another programmable data processing apparatus, or other devices, causing a series of operating steps to be performed on the computer, the other programmable data processing apparatus, or other devices, to produce a computer-implemented process, such that the instructions executed on the computer, the other programmable data processing apparatus, or other devices implement the functions/acts specified in one or more blocks of the flowchart(s) and/or block diagram(s).

The flowchart(s) and block diagram(s) in the drawings show the possibly implemented architectures, functions and operations of the system, method and computer program product according to multiple implementations of the present disclosure. In this regard, each block in the flowchart(s) or block diagram(s) may represent a module, a program segment or a part of instructions, which contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It would also be noted that each block of the block diagram(s) and/or flowchart(s), and combinations of the blocks in the block diagram(s) and/or flowchart(s), may be implemented by a special-purpose hardware-based system that perform specified functions or acts, or may be implemented by a combination of special-purpose hardware and computer instructions.

The implementations of the present disclosure have been described above, and the above description is illustrative, non-exhaustive, and not limited to the disclosed implementations. Without departing from the scope and spirit of the described implementations, many modifications and variations will be apparent to those of ordinary skill in the art. The choice of terms used herein is intended to best explain the principles of each implementation, the practical application or improvement to the technology in the market, or to enable other ordinary skilled in the art to understand the various implementations disclosed herein.

1. A method of data processing, comprising:
determining, based on scene information of a plurality of video segments of a sample video, a set of candidate video segments from the plurality of video segments;
determining a set of candidate audio segments by removing speech content from a plurality of audio segments of a sample audio;
determining correlation information between the set of candidate video segments and the set of candidate audio segments;
determining at least one sample pair based on the correlation information, each sample pair comprising a video segment and a corresponding audio segment; and
constructing, based on the at least one sample pair, a training dataset for training an audio generation model, the audio generation model being configured to generate audio content corresponding to an input video.

2. The method of claim 1, further comprising:
segmenting the sample video into the plurality of video segments corresponding to different storyboards.

3. The method of claim 1, wherein determining, based on the scene information of the plurality of video segments of the sample video, the set of candidate video segments from the plurality of video segments comprises:
determining, based on the scene information of the plurality of video segments of the sample video, whether the plurality of video segments comprise a video segment corresponding to a preset scene; and
removing, in response to the plurality of video segments comprising at least one video segment corresponding to the preset scene, the at least one video segment from the plurality of video segments to determine the set of candidate video segments.

4. The method of claim 3, wherein the preset scene indicates at least one of:
the video segment corresponding to a static image; or
the video segment corresponding to an indoor environment.

5. The method of claim 1, wherein determining the correlation information between the set of candidate video segments and the set of candidate audio segments comprises:
cropping, from the set of candidate video segments, an image part corresponding to subtitle content; and
determining the correlation information between the set of cropped candidate video segments and the set of candidate audio segments.

6. The method of claim 1, further comprising:
segmenting the sample audio into an audio segment set corresponding to a preset length; and
determining, using a sound event detection model, the plurality of audio segments containing sound events from the audio segment set.

7. The method of claim 1, wherein determining the set of candidate audio segments by removing the speech content from the plurality of audio segments of the sample audio comprises:
determining a target video segment corresponding to a first audio segment; and
removing, in response to determining that image content of the target video segment is not related to instrument playing, music content and the speech content from the first audio segment to determine a corresponding candidate audio segment.

8. The method of claim 1, wherein determining the set of candidate audio segments by removing the speech content from the plurality of audio segments of the sample audio comprises:
determining energy corresponding to the speech content removed from a second audio segment; and
adding, in response to the energy being less than a first threshold, the second audio segment from which the speech content has been removed to the set of candidate audio segments.

9. The method of claim 1, wherein a matching degree between the video segment and the corresponding audio segment in the at least one sample pair is greater than a second threshold.

10. The method of claim 1, wherein determining the correlation information between the set of candidate video segments and the set of candidate audio segments comprises:
encoding a plurality of image frames in a candidate video segment to determine a plurality of image feature representations;
determining a video feature representation corresponding to the candidate video segment based on the plurality of image feature representations;
determining a similarity between the video feature representation and an audio feature representation of a candidate audio segment; and
determining the correlation information between the candidate video segment and the candidate audio segment based on the similarity.

11. An electronic device, comprising:
at least one processor; and
at least one memory, the at least one memory being coupled to the at least one processor and storing instructions executable by the at least one processor, the instructions, when executed by the at least one processor, causing the electronic device to perform acts comprising:
determining, based on scene information of a plurality of video segments of a sample video, a set of candidate video segments from the plurality of video segments;
determining a set of candidate audio segments by removing speech content from a plurality of audio segments of a sample audio;
determining correlation information between the set of candidate video segments and the set of candidate audio segments;
determining at least one sample pair based on the correlation information, each sample pair comprising a video segment and a corresponding audio segment; and
constructing, based on the at least one sample pair, a training dataset for training an audio generation model, the audio generation model being configured to generate audio content corresponding to an input video.

12. The electronic device of claim 11, wherein the acts further comprise:
segmenting the sample video into the plurality of video segments corresponding to different storyboards.

13. The electronic device of claim 11, wherein determining, based on the scene information of the plurality of video segments of the sample video, the set of candidate video segments from the plurality of video segments comprises:
determining, based on the scene information of the plurality of video segments of the sample video, whether the plurality of video segments comprise a video segment corresponding to a preset scene; and
removing, in response to the plurality of video segments comprising at least one video segment corresponding to the preset scene, the at least one video segment from the plurality of video segments to determine the set of candidate video segments.

14. The electronic device of claim 13, wherein the preset scene indicates at least one of:
the video segment corresponding to a static image; or
the video segment corresponding to an indoor environment.

15. The electronic device of claim 11, wherein determining the correlation information between the set of candidate video segments and the set of candidate audio segments comprises:
cropping, from the set of candidate video segments, an image part corresponding to subtitle content; and
determining the correlation information between the set of cropped candidate video segments and the set of candidate audio segments.

16. The electronic device of claim 11, wherein the acts further comprise:
segmenting the sample audio into an audio segment set corresponding to a preset length; and
determining, using a sound event detection model, the plurality of audio segments containing sound events from the audio segment set.

17. The electronic device of claim 11, wherein determining the set of candidate audio segments by removing the speech content from the plurality of audio segments of the sample audio comprises:
determining a target video segment corresponding to a first audio segment; and
removing, in response to determining that image content of the target video segment is not related to instrument playing, music content and the speech content from the first audio segment to determine a corresponding candidate audio segment.

18. The electronic device of claim 11, wherein determining the set of candidate audio segments by removing the speech content from the plurality of audio segments of the sample audio comprises:
determining energy corresponding to the speech content removed from a second audio segment; and
adding, in response to the energy being less than a first threshold, the second audio segment from which the speech content has been removed to the set of candidate audio segments.

19. The electronic device of claim 11, wherein determining the correlation information between the set of candidate video segments and the set of candidate audio segments comprises:
encoding a plurality of image frames in a candidate video segment to determine a plurality of image feature representations;
determining a video feature representation corresponding to the candidate video segment based on the plurality of image feature representations;
determining a similarity between the video feature representation and an audio feature representation of a candidate audio segment; and
determining the correlation information between the candidate video segment and the candidate audio segment based on the similarity.

20. A non-transitory computer-readable storage medium having a computer program stored thereon, wherein the computer program, when executed by a processor, performs acts comprising:
determining, based on scene information of a plurality of video segments of a sample video, a set of candidate video segments from the plurality of video segments;
determining a set of candidate audio segments by removing speech content from a plurality of audio segments of a sample audio;
determining correlation information between the set of candidate video segments and the set of candidate audio segments;
determining at least one sample pair based on the correlation information, each sample pair comprising a video segment and a corresponding audio segment; and
constructing, based on the at least one sample pair, a training dataset for training an audio generation model, the audio generation model being configured to generate audio content corresponding to an input video.
